(19) United States
(12) Patent Application Publication
(10) Pub. No.: US 2026/0266363 A1
(43) Pub. Date: Sep. 10, 2026

(54) LIMITED SLIP DIFFERENTIAL FRICTION SURFACE CHARACTERISTICS

(71) Applicant: Schaeffler Technologies GmbH & Co. KG, Herzogenaurach (DE)

(72) Inventors: Michael Hodge, Wadsworth, OH (US); Jordan Geiser, Massillon, OH (US); MATTHEW FOWLER, CANTON, OH (US); Kenneth Hunt, Orrville, OH (US)

(73) Assignee: Schaeffler Technologies GmbH & Co. KG, Herzogenaurach (DE)

(21) Appl. No.: 19/556,832

(22) Filed: Mar. 4, 2026

Related U.S. Application Data
(60) Provisional application No. 63/767,896, filed on Mar. 6, 2025.

(51) Int. Cl. F16H 48/285; F16H 48/10; F16H 48/38; F16H 57/04

(52) U.S. Cl. CPC F16H 48/285; F16H 48/10; F16H 48/38; F16H 57/0483

(57) ABSTRACT

A limited slip differential includes a housing, a first side gear, a second side gear, a cover, and a friction surface contacting a one of the housing, the first side gear, the second side gear, or the cover. The first side gear is disposed in the housing and arranged for driving engagement with a first axle shaft, and the second side gear is disposed in the housing and arranged for driving engagement with a second axle shaft. The cover is secured to the housing to retain the first side gear and the second side gear in the housing. The friction surface has a plurality of depressions arranged for receiving a lubricating oil.

### CROSS-REFERENCE TO RELATED APPLICATIONS

This application claims the benefit of U.S. Provisional Patent Application No.63/767,896, filed March 6, 2025, the disclosure of which is incorporated in its entirety by reference herein.

### TECHNICAL FIELD

The present disclosure relates generally to a limited slip differential, and more specifically to a friction surface for a limited slip differential.

### BACKGROUND

Helical limited slip differentials are known. One example is shown and described in United States Patent No. 9,382,990 titled HELICAL LIMITED SLIP DIFFERENTIAL to Nolte et al., hereby incorporated by reference as if set forth fully herein.

### SUMMARY

Example embodiments broadly comprise a limited slip differential including a housing, a first side gear, a second side gear, a cover, and a friction surface contacting a one of the housing, the first side gear, the second side gear, or the cover. The first side gear is disposed in the housing and arranged for driving engagement with a first axle shaft, and the second side gear is disposed in the housing and arranged for driving engagement with a second axle shaft. The cover is secured to the housing to retain the first side gear and the second side gear in the housing. The friction surface has a plurality of depressions arranged for receiving a lubricating oil.

In an example embodiment, the friction surface is arranged on the housing, the first side gear, the second side gear, or the cover. In an example embodiment, the limited slip differential also includes a friction washer, and the friction surface is arranged on the friction washer. In an example embodiment, the friction surface has a hardness of 600 to 1300 measured on the Vickers hardness scale. In an example embodiment, the friction surface is heat treated by ferritic nitrocarburizing at a temperature below an austenitizing temperature.

In some example embodiments, the limited slip differential also includes a low viscosity oil disposed in the housing for lubricating the friction surface. In an example embodiment, a kinematic viscosity of the low viscosity oil is between 13 and 20 mm²/sec at 40 degrees Celsius. In an example embodiment, the low viscosity oil has little to no sulfur content.

In some example embodiments, the plurality of depressions is distributed in straight rows and straight columns arranged orthogonal to one another. In an example embodiment, the plurality of depressions is arranged in a repeating pattern with 0.9 to 3 mm therebetween. In an example embodiment, each one of the plurality of depressions has a depth between 0.3 mm and 1.5 mm. In some example embodiments, each one of the plurality of depressions has a square base and a square bottom. In an example embodiment, each one of the plurality of depressions has opposite sides extending from the square base to the square bottom arranged at an angle of sixty (60) degrees to one another.

In an example embodiment, the friction surface is an annular surface. In an example embodiment, the limited slip differential has a plurality of friction surfaces.

### BRIEF DESCRIPTION OF THE DRAWINGS

FIG. 1 illustrates a cross-sectional view of a limited slip differential according to an example embodiment.

FIG. 2 illustrates a perspective view of a friction washer of the limited slip differential of FIG. 1.

FIG. 3 illustrates a cross-sectional view of the friction washer of FIG. 2.

FIG. 4 illustrates a perspective view of a first side gear of the limited slip differential of FIG. 1.

FIG. 5 illustrates a perspective view of a second side gear of the limited slip differential of FIG. 1.

FIG. 6 illustrates a perspective view of a housing of the limited slip differential of FIG. 1.

FIG. 7 illustrates a perspective view of a cover of the limited slip differential of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

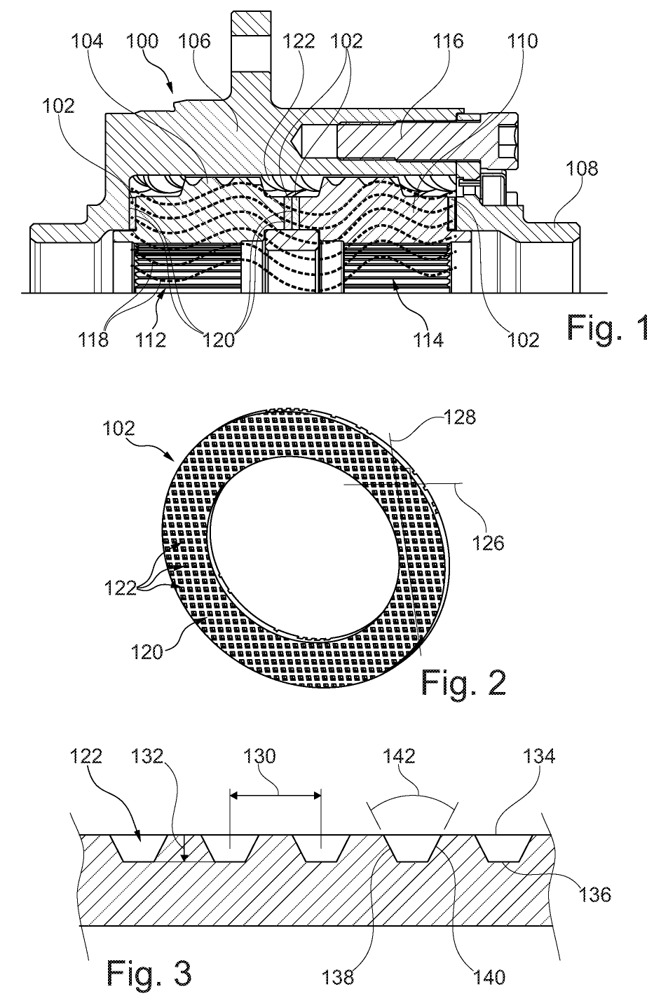

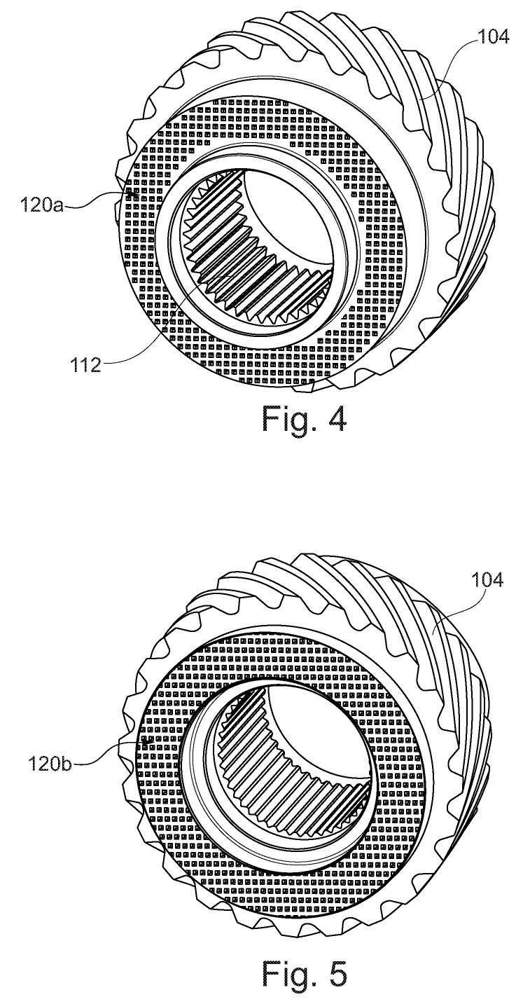

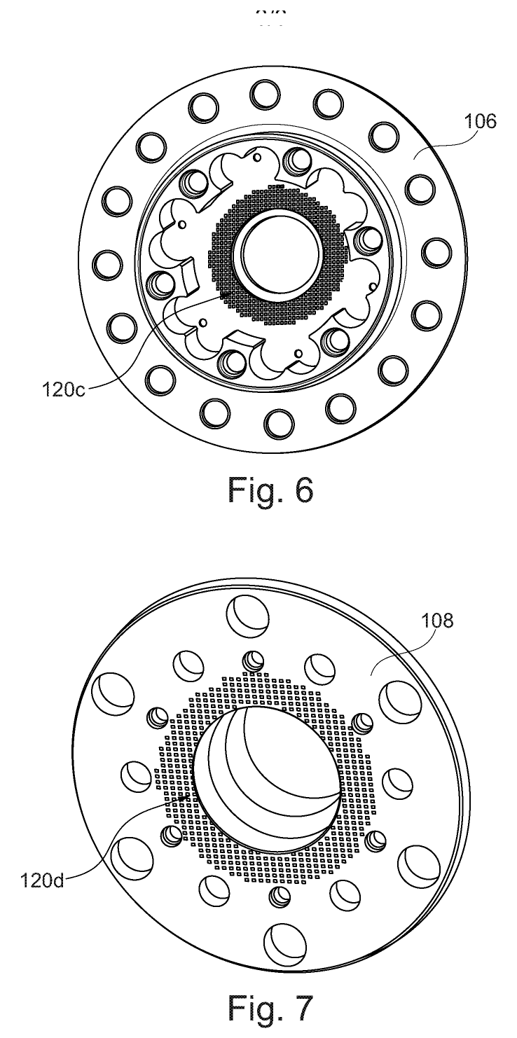

The following description is made with reference to FIGS. 1-7. FIG. 1 illustrates a cross-sectional view of limited slip differential 100 of FIG. 1. FIG. 2 illustrates a perspective view of friction washer 102 of limited slip differential 100. FIG. 3 illustrates a cross-sectional view of friction washer 102 of FIG. 2. FIG. 4 illustrates a front perspective view of side gear 104 of limited slip differential 100 of FIG. 1. FIG. 5 illustrates a back perspective view of side gear 104 of limited slip differential 100 of FIG. 1. FIG. 6 illustrates a perspective view of housing 106 of limited slip differential 100 of FIG. 1. FIG. 7 illustrates a perspective view of cover 108 of limited slip differential 100 of FIG. 1.

Limited slip differential 100 includes housing 106, side gear 104, side gear 110, and cover 108. Side gears 104 and 110 are disposed in the housing and arranged for driving engagement with respective axle shafts (not shown) via respective splines 112 and 114, for example. Cover 108 is secured to the housing via bolts 116, for example, to retain the side gears in the housing. Limited slip differential 100 also includes friction surface 120 having depressions 122 (described in more detail below) arranged for receiving lubricating oil 118 shown as wavy dashed lines in FIG. 1. Pinion gears 124 are arranged to rotationally connect side gears 104 and 110 in a known manner.

Friction surface 120 may be arranged on housing 106, side gears 104 or 110, or cover 108, for example. Limited slip differential 100 also includes friction washer 102. Friction surface 120 may be arranged on the friction washer. FIGS. 2 and 4-7 show examples of the friction surface arranged on the various components, for example. Friction surface 120 may have a hardness of 600 to 1300 measured on the Vickers hardness scale. That is, through a hardening process (e.g., ferritic nitrocarburizing discussed below), the friction surface is harder than the underlying component (e.g., housing, side gear, washer, etc.).

Friction surface 120 may be heat treated by ferritic nitrocarburizing (FNC) at a temperature below an austenitizing temperature of the material. FNC (“Ferritic Nitrocarburizing”) is a heat treatment for iron-based materials (steel, cast iron) that is a variant of the gas nitriding process. It is usually performed at a temperature in the vicinity of 570°C (~1060°F), which is below iron’s transformation temperature from ferrite to austenite, and that is why it is called “Ferritic” nitrocarburizing. This low processing temperature, and lack of phase transformation, results in low distortion in parts processed by FNC.

FNC produces a hard, wear-resistant layer (known as the “compound layer”, or “white layer”) on the surface of the treated part. However, the diffusion of nitrogen below the surface of the treated part can also result in an improvement in fatigue strength and subsurface hardness, if the material and cooling rate from the processing temperature are properly chosen.

Limited slip differential 100 also includes low viscosity oil 118 disposed in the housing for lubricating the friction surface. A kinematic viscosity of the low viscosity oil may be between 13 and 20 mm2/sec at 40 degrees Celsius, and the low viscosity oil may have little to no sulfur content. Little or no sulfur in the low viscosity oil limits sulfur corrosion of electric motors that forms conductive copper sulphide. Such an oil is desirable due to its electrical and mechanical compatibility with electric motors, allowing limited slip differential 100 to be used for electric axles, for example. Friction surface 120, described herein, improves durability of limited slip differential 100, in nonconventional gear lubricants.

As best seen in FIG. 2, for example, depressions 122 are distributed in straight rows 126 and straight columns 128 arranged orthogonal to one another. As shown in FIG. 3, depressions 122 are arranged in a repeating pattern with 0.9 to 3 mm therebetween (indicated by distance 130). Depressions 122 each have a depth 132 between 0.3 mm and 1.5 mm. Depressions 122 each have square base 134 and square bottom 136. Depressions 122 each have opposite sides 138 and 140 extending from the square base to the square bottom. Sides 138 and 140 are arranged at an angle of sixty (60) degrees to one another (as indicated by angle 142). As shown in FIGS. 2 and 4-7, for example, friction surface 120 is an annular surface. In the embodiment shown in FIG. 1, for example, limited slip differential 100 includes a plurality of friction surfaces 120. In other words, any or all of the discussed components may include friction surface 120 (also designated as 120a, 120b, etc.), and some components (e.g., friction washer 102) may include two friction surfaces 120 on opposite sides of the washer.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Limited slip differential

102 Friction washer

104 Side gear (first)

106 Housing

108 Cover

110 Side gear (second)

112 Spline (first side gear)

114 Spline (second side gear)

116 Bolts

118 Lubricating oil

120 Friction surface

122 Depressions (friction surface)

124 Pinion gears

126 Rows (depressions)

128 Columns (depressions)

130 Distance (between depressions)

132 Depth (depressions)

134 Base (depressions)

136 Bottom (depressions)

138 Side (depressions)

140 Side (depressions)

142 Angle (between sides)

What is claimed is:

1. A limited slip differential, comprising:
a housing;
a first side gear, disposed in the housing and arranged for driving engagement with a first axle shaft;
a second side gear, disposed in the housing and arranged for driving engagement with a second axle shaft; and
a cover secured to the housing to retain the first side gear and the second side gear in the housing; and
a friction surface contacting a one of the housing, the first side gear, the second side gear, or the cover, and comprising a plurality of depressions arranged for receiving a lubricating oil.

2. The limited slip differential of claim 1, wherein the friction surface is arranged on the housing, the first side gear, the second side gear, or the cover.

3. The limited slip differential of claim 1, further comprising a friction washer, wherein the friction surface is arranged on the friction washer.

4. The limited slip differential of claim 1, wherein the friction surface has a hardness of 600 to 1300 measured on the Vickers hardness scale.

5. The limited slip differential of claim 1, wherein the friction surface is heat treated by ferritic nitrocarburizing at a temperature below an austenitizing temperature.

6. The limited slip differential of claim 1, further comprising a low viscosity oil disposed in the housing for lubricating the friction surface.

7. The limited slip differential of claim 6, wherein a kinematic viscosity of the low viscosity oil is between 13 and 20 mm²/sec at 40 degrees Celsius.

8. The limited slip differential of claim 6, wherein the low viscosity oil has little to no sulfur content.

9. The limited slip differential of claim 1, wherein the plurality of depressions is distributed in straight rows and straight columns arranged orthogonal to one another.

10. The limited slip differential of claim 9, wherein the plurality of depressions is arranged in a repeating pattern with 0.9 to 3 mm therebetween.

11. The limited slip differential of claim 1, wherein each one of the plurality of depressions has a depth between 0.3 mm and 1.5 mm.

12. The limited slip differential of claim 1, wherein each one of the plurality of depressions has a square base and a square bottom.

13. The limited slip differential of claim 12, wherein each one of the plurality of depressions comprises opposite sides extending from the square base to the square bottom arranged at an angle of sixty (60) degrees to one another.

14. The limited slip differential of claim 1, wherein the friction surface is an annular surface.

15. The limited slip differential of claim 1, further comprising a plurality of friction surfaces.
